(19) United States
(12) Patent Application Publication
(10) Pub. No.: US 2025/0326129 A1
(43) Pub. Date: Oct. 23, 2025

(54) ROBOT CONTROL METHOD, ROBOT, ARTICLE MANUFACTURING METHOD USING ROBOT, INFORMATION PROCESSING METHOD, AND STORAGE MEDIUM

(71) Applicant: CANON KABUSHIKI KAISHA, Tokyo (JP)

(72) Inventors: MOTOHIRO HORIUCHI, Kanagawa (JP); TAISHI MATSUMOTO, Kanagawa (JP); TOMOHIRO HARA, Kanagawa (JP)

(21) Appl. No.: 19/183,559

(22) Filed: Apr. 18, 2025

(30) Foreign Application Priority Data
Apr. 23, 2024 (JP) 2024-070112

(51) Int. Cl. B25J 9/16; B25J 11/00; B25J 13/08; B25J 19/02; G06T 7/70

(52) U.S. Cl. CPC B25J 9/1697; B25J 9/1687; B25J 11/005; B25J 13/085; B25J 19/023; G06T 7/70; G06T 2207/30204

(57) ABSTRACT

A robot system includes a robot, an image capturing apparatus, and a control apparatus. The control apparatus obtains information about a position of a portion functioning as a marker to be obtained by the robot and information about a position of the portion functioning as the marker to be obtained by the image capturing apparatus and controls the robot based on the information about the position of the portion functioning as a marker to be obtained by the robot and the information about the position of the portion functioning as the marker to be obtained by the image capturing apparatus.

### BACKGROUND

### Field

The present disclosure relates to a robot control method, a robot, an article manufacturing method using robot, an information processing method, and a storage medium.

### Description of the Related Art

A system for correcting an operation of a robot with a robot vision, such as a camera, using the robot and the camera in combination as discussed in International Patent Publication No. WO 2018/092236 and Japanese Patent Application Laid-Open No. 2016-78195 has heretofore been known. Such a system enables the robot to execute a desired operation by correcting the robot vision.

In the robot system discussed in International Patent Publication No. WO 2018/092236 or Japanese Patent Application Laid-Open No. 2016-78195, the position of the robot indicated by a command value cannot be reproduced and the position of the robot deviates from the position indicated by the command value due to mechanical characteristics, such as a backlash of a mechanical portion of the robot, calculation errors during calibration of a relative orientation between an image capturing apparatus and the robot, and the like. This may cause a failure in robot's work in the case of causing the robot to perform a work that requires a high positional accuracy. International Patent Publication No. WO 2018/092236 discusses a means for correcting factors attributable to the mechanism of the robot.

However, a camera for a robot vision system is not taken into consideration in International Patent Publication No. WO 2018/092236, which makes it difficult to correct the influence caused by factors attributable to calibration between the camera and the robot. Japanese Patent Application Laid-Open No. 2016-78195 discusses a means for improving the accuracy of calibration between the camera and the robot. Japanese Patent Application Laid-Open No. 2016-78195 merely considers the calibration of a relative orientation between the camera and the robot, but fails to correct the influence caused by factors attributable to the mechanism of the robot.

### SUMMARY

According to an aspect of the present disclosure, it is possible to improve the operation accuracy of a robot.

According to an aspect of the present disclosure, a method for a robot controlled by an image capturing apparatus includes causing a control apparatus to obtain information about a position of a portion functioning as a marker to be obtained by the robot and information about a position of the portion functioning as the marker to be obtained by the image capturing apparatus and controlling the robot based on the information about the position of the portion functioning as a marker to be obtained by the robot and the information about the position of the portion functioning as the marker to be obtained by the image capturing apparatus.

Further features of the present disclosure will become apparent from the following description of exemplary embodiments with reference to the attached drawings.

### BRIEF DESCRIPTION OF THE DRAWINGS

FIG. 1 is a schematic view of a robot system according to an exemplary embodiment.

FIG. 2 is a schematic view of a marker according to the first exemplary embodiment.

FIG. 3 is a block diagram illustrating a control apparatus according to an exemplary embodiment.

FIG. 4 is a control flowchart according to an exemplary embodiment.

FIG. 5 is an explanatory view illustrating placement of each marker according to an exemplary embodiment.

FIGS. 6A and 6B illustrate placement of each marker according to an exemplary embodiment.

FIGS. 7A and 7B illustrate placement of each marker according to an exemplary embodiment.

FIG. 8 is a control flowchart according to an exemplary embodiment.

FIG. 9 illustrates a correction value table according to an exemplary embodiment.

FIG. 10 illustrates a correction map according to an exemplary embodiment.

FIG. 11 illustrates a correction value interpolation method on the correction map according to an exemplary embodiment.

FIG. 12 illustrates a state where a work for fitting an assembly workpiece into a hole of an assembled workpiece is being performed according to an exemplary embodiment.

FIG. 13 illustrates a case where a command value for a robot according to an exemplary embodiment is corrected.

FIG. 14 is a control flowchart according to an exemplary embodiment.

FIG. 15 illustrates an outline of a workpiece assembly using an on-hand image capturing apparatus according to an exemplary embodiment.

FIG. 16 illustrates an example of a graphical user interface (GUI) for setting placement positions according to an exemplary embodiment.

FIG. 17 is a schematic view of a robot system according to an exemplary embodiment.

FIG. 18 is a schematic view of a robot system according to an exemplary embodiment.

FIG. 19 is a schematic view of a robot system according to an exemplary embodiment.

FIG. 20 is a schematic view of a robot system according to an exemplary embodiment.

FIG. 21 is a schematic view of a robot system according to an exemplary embodiment.

### DESCRIPTION OF THE EMBODIMENTS

According to an aspect of the present disclosure, it is possible to improve the operation accuracy of a robot.

Modes for implementing the present disclosure will be described below with reference to exemplary embodiments illustrated in the accompanying drawings.

The exemplary embodiments described below are only illustrative, and, for example, the configuration of detailed parts may be modified as needed by persons skilled in the art without departing from the scope of the present disclosure. Numeric values described in the exemplary embodiments are reference numeric values and are not seen to be limiting. In the following drawings, arrows x, y, and z in the drawings represent the overall coordinate system of a robot system. In general, an xyz three-dimensional coordinate system represents a world coordinate system of an overall installation environment. In addition, for the sake of convenience of control, a local coordinate system may be used as needed.

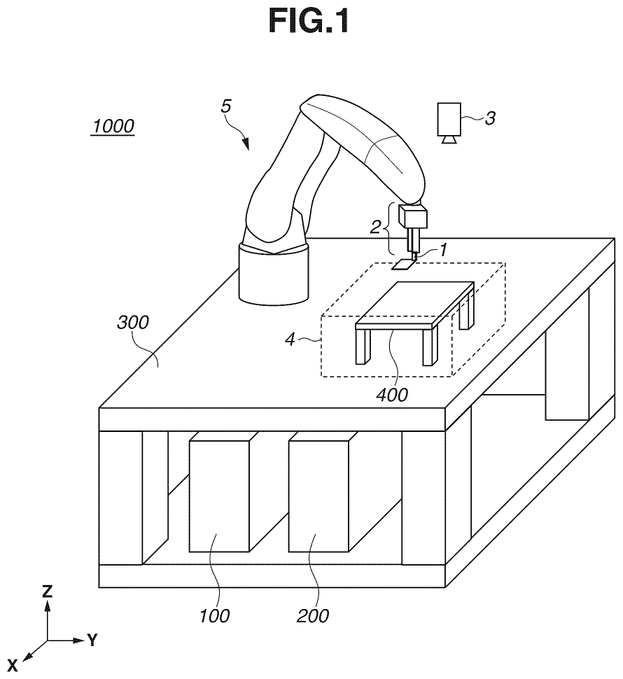

A first exemplary embodiment of the present disclosure will be described below. FIG. 1 illustrates a schematic configuration of a robot system 1000 according to the first exemplary embodiment of the present disclosure. The robot system 1000 includes a robot 5 including an end effector 2, an image capturing apparatus 3, a robot control apparatus 100, a programmable logic controller (PLC) 200, a base 300, and a table 400. A working area 4 for the robot 5 to perform a work is set in the robot system 1000. As described below, the operation of the robot 5 is corrected with a marker 1 placed on the table 400 or the base 300 to improve the operational accuracy of the robot 5 in the working area 4. The marker 1 includes a portion that functions as a marker. The robot 5, the table 400, the robot control apparatus 100, and the PLC 200 are mounted in the base 300. The configuration of the robot system 1000 is not limited to this configuration. For example, the robot 5, the table 400, the robot control apparatus 100, and the PLC 200 may be placed at locations other than the base 300. The robot control apparatus 100 may also be referred to as an information processing apparatus.

While FIG. 1 illustrates an example where the working area 4 is a cube-shaped area, the working area 4 is not limited to this shape. The shape of the working area 4 may be set in any shape, such as a cylindrical shape, a planar shape, or a triangular shape, depending on the work to be executed by the robot 5. A surface on which the marker 1 is disposed in the working area 4 is to be a two-dimensional plane. In the case of performing a three-dimensional work in the working area 4, the table 400 for disposing the marker 1 may be placed and the placement surface of the table 400 can be set to be variable in the z-axis direction.

The position of the table 400 in the vertical direction may desirably be known, but may be unknown if the depth accuracy in the orientation measurement performed by the image capturing apparatus 3 is sufficiently high. The image capturing apparatus 3 is fixed to a frame such as a ceiling or a top board so that image capturing apparatus 3 can overlook the working area 4.

The robot 5 is a manipulator and includes the end effector 2 serving as a holding portion. The robot 5 is a vertical articulated robot arm. While the present exemplary embodiment illustrates an example where the robot 5 is a six-axis robot, the configuration of the robot 5 is not limited to this example. The end effector 2 is a robot hand and is attached to a predetermined portion, for example, a leading end of a robot arm portion. While the present exemplary embodiment illustrates an example where the end effector 2 is a robot hand, the configuration of the end effector 2 is not limited to this example. Various tools such as a screw driver, a cutting tool, a grinding tool, and an adsorption hand may be used. In the present exemplary embodiment, the end effector 2 is configured to grip the marker 1 with finger portions.

The above-described configuration enables the robot 5 to move the end effector 2 to a certain position and perform a desired work. For example, an assembly workpiece can be manufactured as a product by performing processing of assembling a workpiece with another workpiece using these workpieces as materials. The above-described configuration enables the robot system 1000 to manufacture an article. While the present exemplary embodiment illustrates an example where the robot system 1000 is used to manufacture an article by assembling workpieces, the configuration of the robot system 1000 is not limited to this example. For example, tools such as a cutting tool and a grinding tool may be provided as the end effector 2 and workpieces may be processed using such tools to manufacture an article.

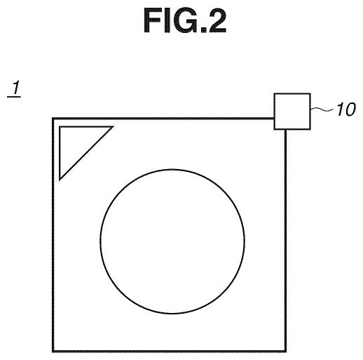

FIG. 2 illustrates an example of the marker 1. The marker 1 includes a grip portion 10 with which the end effector 2 can grip an object. However, the grip portion 10 does not necessarily need to be specially provided. Depending on the shape of the marker 1, the outer shape or components of the marker 1 may be designed to have the function of the grip portion 10. If the marker 1 is provided with the grip portion 10, a relative positional relationship between an orientation of a leading end of the end effector 2 when the end effector 2 grips the grip portion 10 and an orientation obtained when the marker 1 is measured by the image capturing apparatus 3 is known in advance.

The marker 1 has a mechanism for uniquely measuring the orientation of the marker 1 when an image of the marker 1 is captured by the image capturing apparatus 3. A figure including one triangle and one circle is printed as the marker 1. The configuration of the marker 1 is not limited as long as the orientation of the marker 1 can be uniquely measured. Any other symbols may also be used. A workpiece used for an actual work to be performed by the robot 5 may also be used as the marker 1. The marker 1 takes a stable orientation when the marker 1 is gripped by the end effector 2 and is placed at a specific position.

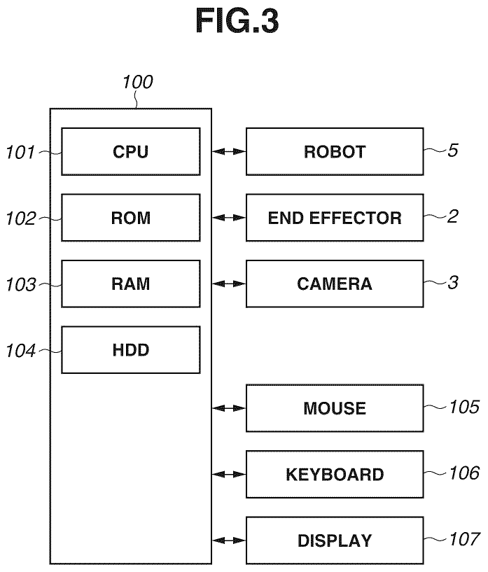

Next, the robot control apparatus 100 will be described. FIG. 3 is a block diagram of the robot control apparatus 100. The robot control apparatus 100 includes a central processing unit (CPU) 101 as an example of a processor/processor unit. The robot control apparatus 100 also includes a read-only memory (ROM) 102, a random access memory (RAM) 103, and a hard disk drive (HDD) 104 as a storage unit. The robot control apparatus 100 is connected to the robot 5, the end effector 2, and the image capturing apparatus 3 in a communicable manner, and is configured to control each connected element. The CPU 101, the ROM 102, the RAM 103, the HDD 104, the robot 5, the end effector 2, and the image capturing apparatus 3 are connected via a bus in a communicable manner. In addition, a mouse 105, a keyboard 106, a display 107, and the like are connected as an interface for the robot control apparatus 100.

The ROM 102 stores basic programs for operation of a computer. The RAM 103 is a storage device that temporarily stores various data such as arithmetic processing results from the CPU 101. The HDD 104 stores arithmetic processing results from the CPU 101, various externally obtained data, such as data obtained from sensors included in the robot 5 and images obtained from the image capturing apparatus 3, and the like, and stores programs for causing the CPU 101 to execute various types of processing. Programs stored in the HDD 104 are application software that can be executed by the CPU 101. By executing the programs stored in the HDD 104, the CPU 101 executes control processing for the robot 5 and the image capturing apparatus 3 as described below.

In the present exemplary embodiment, the HDD 104 is a computer-readable non-transitory storage medium and stores programs. The configuration of the HDD 104 is not limited to this example. Programs may be stored in any computer-readable non-transitory storage media. Examples of a storage medium used to supply programs to the computer include a flexible disk, a hard disk, an optical disk, a magneto-optical disk, a magnetic tape, a non-volatile memory. A solid-state drive (SSD) may also be used. In the present exemplary embodiment, the robot 5 and the image capturing apparatus 3 are controlled by a single control apparatus, but any number of control apparatuses are applicable.

The CPU 101 executes programs stored in the HDD 104 to cause the image capturing apparatus 3 to capture an image of a predetermined region. The image obtained by image capturing is used to correct control errors of the robot 5 caused by mechanical factors of the robot 5 and factors attributable to a relative positional relationship between the robot 5 and the image capturing apparatus 3. The CPU 101 executes programs stored in the HDD 104 so that the image capturing apparatus 3 captures an image of a region in the real space and measures the position and orientation of the marker 1 using pattern matching processing, which is an example of image processing. The CPU 101 executes programs stored in the HDD 104 to control the robot 5 to move the end effector 2 to a predetermined position in the real space. The CPU 101 executes programs stored in the HDD 104 to cause the end effector 2 to hold the marker 1 and to move the marker 1 to a predetermined position.

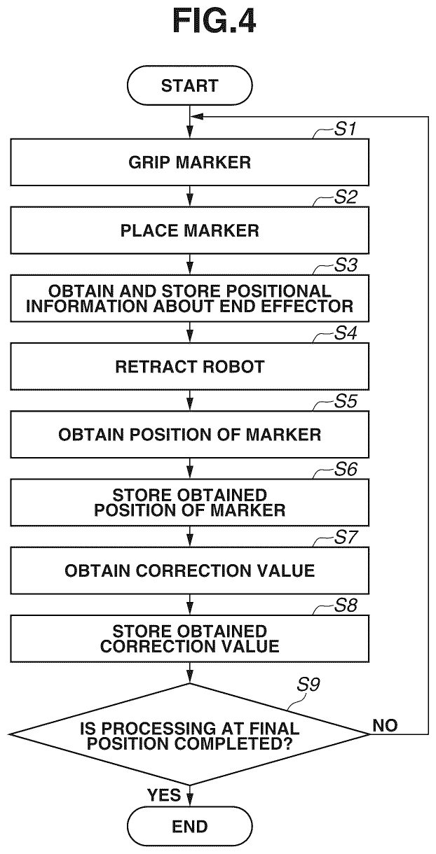

Next, a method of obtaining a correction value for correcting a command value for the robot 5 to correct the operation of the robot 5 will be described. FIG. 4 is a flowchart illustrating a method of obtaining data to obtain the correction value. In this example, the method in the flowchart illustrated in FIG. 4 is executed by the robot control apparatus 100.

As illustrated in FIG. 4, initially, in step S1, the robot 5 and the end effector 2 are controlled to cause the end effector 2 to grip the marker 1. Any method may be used to cause the end effector 2 to grip the marker 1. For example, the orientation in which the end effector 2 can grip the marker 1 may be taught to the robot 5 to cause the robot 5 to grip the marker 1, or the end effector 2 may be manually caused to grip the marker 1 when the robot 5 is in a stopped state.

Next, in step S2, the gripped marker 1 is placed at any position in the working area 4.

A method of placing the marker 1 will be described below.

Next, in step S3, positional information (placement position) about the end effector 2 in a case where the marker 1 is placed is obtained from an encoder incorporated in each joint of the robot 5, and the obtained positional information is stored in a storage medium in the robot control apparatus 100. The placement position obtained in step S3 refers to a position at which the end effector 2 stabilizes at the position where the marker 1 is placed. In other words, a position where the end effector 2 releases the grip of the marker 1. In this case, the positional information about the end effector 2 obtained when the end effector 2 releases the grip of the marker 1 is used. Positional information about the end effector 2 obtained before the end effector 2 releases the grip of the marker 1 may be used. Assume that the positional information in this case is three-dimensional coordinates (x, y, z) of the leading end of the end effector 2. The positional information to be obtained is not particularly limited, and any regions to be controlled, such as the center of a mounting flange of the end effector 2, or another form such as a homogeneous transformation matrix, may be used. The positional information about finger portions gripping the marker 1 based on the positional relationship of the mechanism in the end effector 2 may be used.

After the positional information about the end effector 2 is obtained in step S3, the processing proceeds to step S4. In step S4, the robot 5 is retracted so that the placed marker 1 can be measured without any blind spot from the image capturing apparatus 3.

In this case, however, if the position of the marker 1 can be measured without retracting the robot 5, step S4 may be skipped.

In step S5, the position of the marker 1 is obtained (measured) using the image capturing apparatus 3. The positional information to be obtained may be desirably stored in the same format as that used in step S3, but any format that enables interconversion is applicable. As a method of obtaining the positional information, the pattern of the marker 1 may be preliminarily registered and the positional information about the marker 1 may be obtained through pattern matching. The positional information about the marker 1 may be obtained using contour information. In addition, any other means for measuring positional information based on a two-dimensional image may be used.

In step S6, the measured position of the marker 1 is stored in the storage medium in the robot control apparatus 100 as in step S3.

In step S7, a correction value for correcting the command value used to control the robot 5 is obtained (calculated) based on the positional information about the end effector 2 obtained in step S3 and the positional information about the marker 1 obtained from the image capturing apparatus 3 in step S6. A calculation method will be described below.

In step S8, the calculated correction value is stored in the HDD 104 in the robot control apparatus 100. The above-described processing is performed on at least two positions within the working area 4. In step S9, it is determined whether processing at the final position is completed. If the processing at the final position is completed (YES in step S9), the process of obtaining data for calculating the correction value is completed. If the processing at the final position is not completed (NO in step S9), the processing returns to step S1 to execute the processing of gripping the marker 1, placing the marker 1 at another position, obtaining each positional information, and obtaining the correction value. The number of positions where the marker 1 is placed may be feely set by a user depending on the size of the working area 4 in which a work is to be executed and the accuracy of the work to be executed.

In moving the robot 5 to a certain position within the working area 4, a correction map serves a mechanism for outputting the correction value corresponding to a command value, which is the position coordinates of the destination of the robot 5, using the command value as input and the correction values obtained from the flowchart in FIG. 4. The command value used in this case indicates three-dimensional coordinates (x, y, z) represented as continuous values within the working area 4 and is not limited to the placement position of the marker 1 represented by discrete values. This mechanism may be any form, such as a functional form or a tabular form, as long as the relationship between the command value and the correction value can be output.

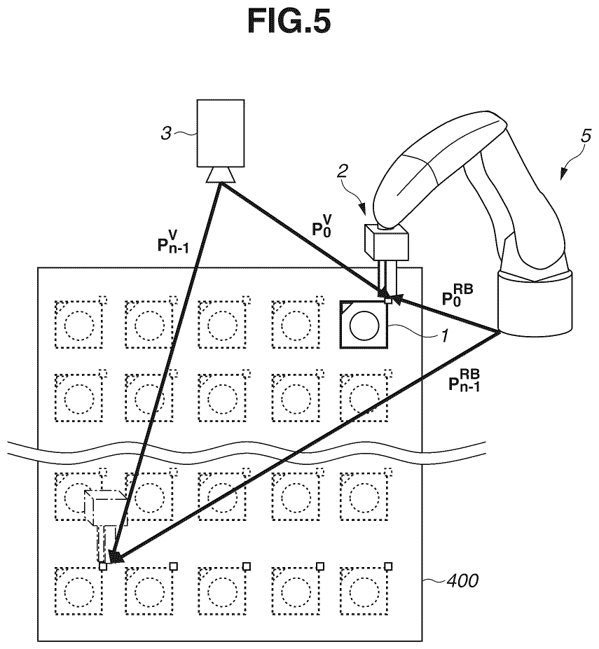

Next, a method of placing the marker 1 in step S2 and a method of calculating a correction value in step S7 will be described. FIG. 5 illustrates a form for a method of placing the marker 1 in step S2, and illustrates a state where the markers 1 are placed in a lattice shape on the table 400 in the working area 4. In step S2, the position at which each marker 1 is placed is set in advance. Instead of using the table 400, the markers 1 may be directly placed on the base 300 or the ground within the working area 4. Instead of placing the markers 1 in a lattice shape, the markers 1 may be placed on at least two positions. By placing a large number of markers 1 evenly throughout the working area 4, local tendencies of the correction values within the working area 4 can be obtained. Thus, the effect of correction using the correction map finally obtained is enhanced, so that it is desirable to place a larger number of markers 1.

The same marker 1 to be placed may be re-grasped and re-placed, or if a plurality of markers 1 of the same shape are available, a new marker 1 can be placed without repositioning the previously placed marker 1. Due to the hysteresis effect of the robot 5, the actual orientation of the robot 5 at the destination may change depending on the path taken by the robot 5 to move to the orientation in which the marker 1 is placed. To reduce this effect, a path for the robot 5 to operate in placing the marker 1 may be generated so as to follow the path for the robot 5 to operate in a work to be actually performed by the robot 5. This makes it possible to reduce the hysteresis effect on the correction value to be obtained.

In a case where the robot 5 follows a complex path during the actual work execution to operate, a plurality of patterns for the path is prepared for the placement of the marker 1. A plurality of correction maps may be generated using correction values obtained on each path, and a correction map can be selectively used based on the path the robot 5 follows. In the case of using a plurality of Tool Center Points (TCPs) in an actual work execution of the robot 5, a correction map may be obtained for the respective TCPs by placing the marker 1 in a state adapted to each TCP, and a correction map may selectively be used depending on the TCP to be used.

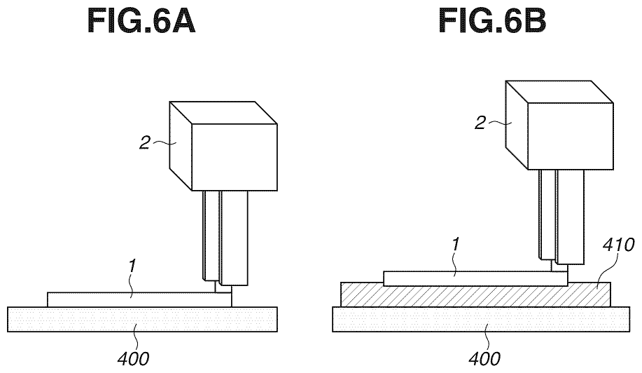

In placing the marker 1, it is to be ensured that the position of the marker 1 does not move (change) as much as possible before and after releasing the grip. FIGS. 6A and 6B illustrate details of a case where the marker 1 is placed on the table 400 by the end effector 2. As illustrated in FIG. 6A, it is desirable to stabilize the end effector 2 in a state where the marker 1 is brought into contact with the table 400 as much as possible and release the grip. Thus, in setting the placement position of marker 1, it is desirable to register the position and orientation of the robot 5 and the end effector 2, as well as the gripping posture, so that the marker 1 is in contact with the table 400. As illustrated in FIG. 6B, the table 400 may be provided with an elastic material 410 having a low coefficient of friction, such as a rubber sheet, to facilitate pressing of the marker 1.

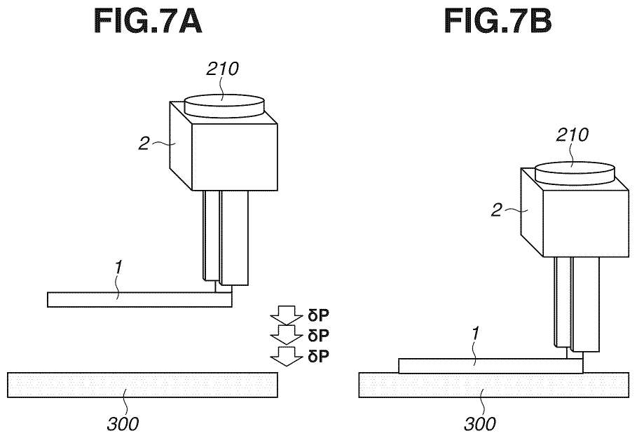

The marker 1 may be placed using a force sensor 210, in the end effector 2, for obtaining (measuring) a load applied in the direction in which the marker 1 is placed. FIGS. 7A and 7B illustrate details of a case where the marker 1 is placed by the end effector 22 including the force sensor 210.

Using the force sensor 210, which measures the load (force-related information) applied in the direction in which the end effector 2 performs placement as illustrated in FIG. 7A, the end effector 2 is moved towards the table 400 in increments of δP until the force sensor 210 indicates a predetermined value. As illustrated in FIG. 7B, the marker 1 may be brought into contact with the table 400 and the robot 5 may be stabilized at a position at which the force sensor 210 indicates the predetermined value. The encoder value of the robot 5 obtained at the time may be set to the placement position. δP represents a vector indicating three-dimensional coordinates (x, y, z).

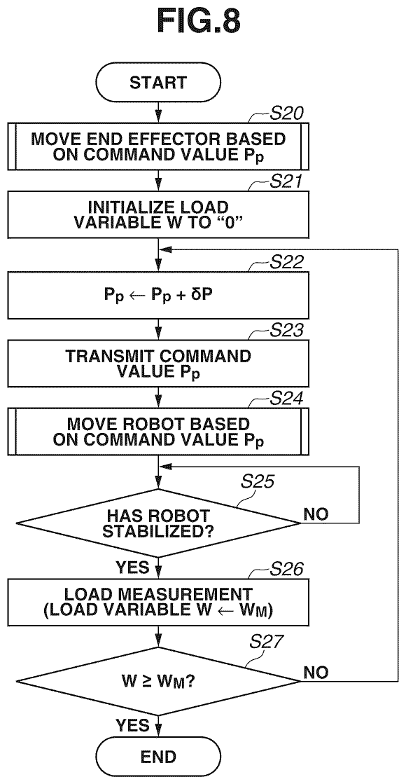

FIG. 8 illustrates control processing (step S2, step S3) in placing the marker 1 using the force sensor 210. A method in the flowchart illustrated in FIG. 8 is executed by the robot control apparatus 100. As illustrated in FIG. 8, in step S20, the end effector 2 is moved using a command value Pₚ so that the end effector 2 is moved to the position preliminarily set to the placement position, as in the case where the force sensor 210 is not used. Next, in step S21, a load variable W is initialized to zero. Next, in step S22, the command value Pₚ is displaced by δP in the pressing direction. Next, in step S24, the command value Pₚ is transmitted to the robot 5. In step S24, the robot 5 is moved based on the command value Pₚ. Next, in step S25, it is determined (checked) whether the robot 5 has stabilized. In the determination of stabilization, if a variation in the encoder value of the robot 5 within a predetermined period is less than or equal to a predetermined amount, it is determined that the robot 5 has stabilized. In step S25, it may be determined that the robot 5 has stabilized after waiting for a predetermined period or longer.

If it is confirmed that the robot 5 has stabilized (YES in step S25), the processing proceeds to step S26. In step S26, a load Wₘ applied to the end effector 2 is measured using the force sensor 210 and the load Wₘ is substituted into the load variable W.

Next, in step S27, it is determined whether the load variable W is more than or equal to a predetermined threshold W_{M} at which a predetermined state is obtained. If the load variable W is more than or equal to the predetermined threshold W_{M} (YES in step S27), it is determined that the placement is completed at the position and the position of the end effector 2 obtained at the time is stored as the placement position. Then, the processing is ended. If the load variable W is less than or equal to the predetermined threshold W_{M} (NO in step S27), the processing returns to step S22 to repeat the processing again. The processing described above makes it possible to obtain the position and orientation of the end effector 2 when the marker 1 is placed using the force sensor 210.

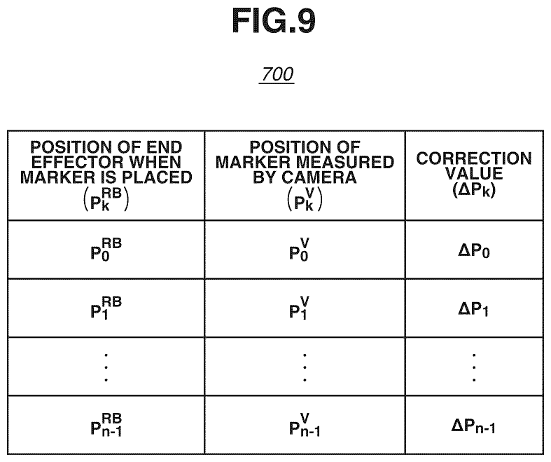

FIG. 9 illustrates a correction value table 700 in which correction values are recorded. In the case of placing n markers 1 in total, the position of the end effector 2 obtained by the encoder of the robot 5 when the (0≤k≤n−1)th marker 1 is placed is represented as P^{RB}ₖ. The position P^{RB}ₖ is recorded in the form of the correction value table 700 as illustrated in FIG. 9. In recording a measured position P^{V}ₖ of the marker 1 obtained by the image capturing apparatus 3 in step S6, the measured position P^{V}ₖ is recorded on the row corresponding to the position P^{RB}ₖ. In addition to the form of the correction value table 700, any forms may be used to store the measured position as long as the correspondence relationship between the position P^{V}ₖ and the position P^{RB}ₖ can be recorded.

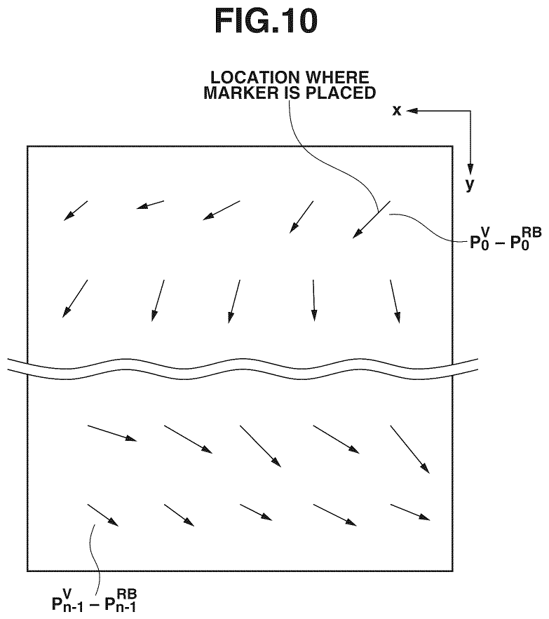

As indicated by the following equation, the difference in x and y components between the recorded position P^{RB}ₖ and the position P^{V}ₖ corresponds to a correction value ΔPₖ at a position k where the marker 1 is placed. In this case, the correction value ΔPₖ is represented as a vector with a starting point corresponding to the position at which the marker 1 is placed as illustrated in FIGS. 7A and 7B and with a magnitude corresponding to each component, thus visualizing an error tendency of the orientation of the robot 5 within the placement surface for the marker 1. FIG. 10 illustrates an example where correction values only on an xy-plane are visualized. In addition, correction values on an xz-plane and a yz-plane may also be visualized.

$$Δ {P}_{k} = ( \begin{matrix}{( {P}_{k}^{V} )}_{x} - {( {P}_{k}^{RB} )}_{x} \\ {( {P}_{k}^{V} )}_{y} - {( {P}_{k}^{RB} )}_{y}\end{matrix} ) \qquad Equation ( 1 )$$

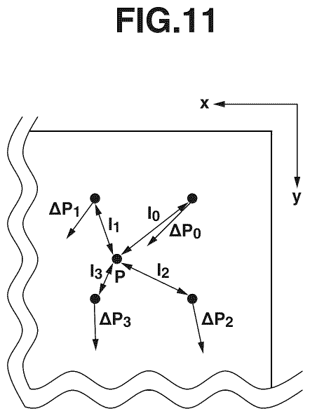

Next, a correction value interpolation method on the correction map will be described with reference to FIG. 11. The position at which the marker 1 is placed in step S2 is not always the same as the position at which the work is actually executed by the robot 5. Thus, to associate the position information about the robot 5, which is continuous values, with the correction values, the correction values are to be continuously interpolate at positions other than where the correction values have been obtained. In this case, continuous interpolation between the obtained correction values can be performed by calculating the weighted average of the correction values in the vicinity of the working position.

FIG. 11 illustrates an outline of calculation of the correction value ΔP at a working position P from the correction values in the vicinity of the working position P. Correction values ΔP₀, ΔP₁, ΔP₂, and ΔP₃ are calculated at placement positions (k=0, 1, 2, 3), respectively, of the marker 1 in the vicinity of the working position P. In this case, if the Euclidean distances on the placement plane for the marker 1 between the placement positions where each correction value is obtained and the working positions P are l₀, l₁, l₂, and l₃, the correction value ΔP at the working position P can be obtained as the weighted average of the distances, as expressed by the following equation.

$$Δ {P}_{k} = \frac{{l}_{0} Δ {P}_{0} + {l}_{1} Δ {P}_{1} + {l}_{2} Δ {P}_{2} + {l}_{3} Δ {P}_{3}}{{l}_{0} + {l}_{1} + {l}_{2} + {l}_{3}} \qquad Equation ( 2 )$$

In the above Equation (2), the markers 1 are placed in a lattice shape in step S2. If the markers 1 are not placed in a lattice shape, the correction value ΔP may be obtained by the weighted average of correction values within a certain Euclidean distance on the placement plane for the marker 1 from the working position P. If the correction value is obtained on a plurality of surfaces with different heights within the working area 4 using the table 400, the above-described weighted average may be calculated by three-dimensionally expanding the weighted average. Any other interpolation method such as an unweighted average value may be used. The above-described interpolation calculation may be omitted depending on a command value correction method using a correction map to be described below.

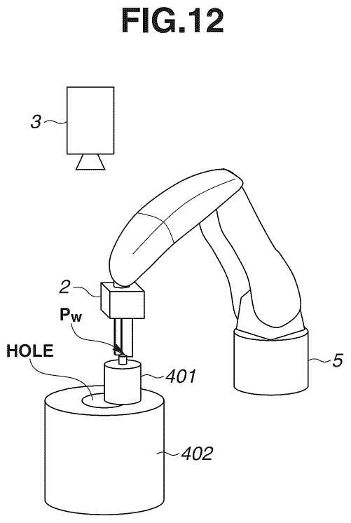

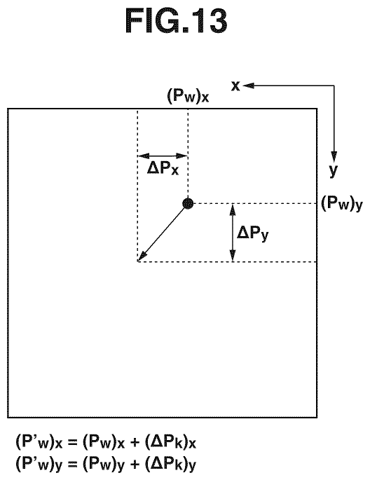

Next, a method for correcting the working position P of the robot 5 using the correction map illustrated in FIG. 10 will be described. FIG. 12 illustrates a state where a work for fitting an assembly workpiece 401 into a hole of a to-be-assembled workpiece 402 in a state where no correction is made using the correction map. In this case, a command value for the robot 5 to be obtained based on a measurement result of the image capturing apparatus 3 in the state where no correction is made is represented as P_{w}. If the correction map interpolation calculation as described above is performed, as illustrated in FIG. 13, an xy position components (ΔPₖ)ₓ and (ΔPₖ)_{y} of the correction value recorded on the xy position on the correction map corresponding to xy position components of a command value P_{w} for the robot 5 are referred to. A corrected command value P′_{w} is obtained through addition to the command value. The correction value ΔP with a shortest distance from the command value P_{w} may be used. In Equation (1), when l₃<l₁<l₀<l₂ holds, ΔP is ΔP₃. In this case, the above-described interpolation calculation may be omitted although the correction effect can be decreased.

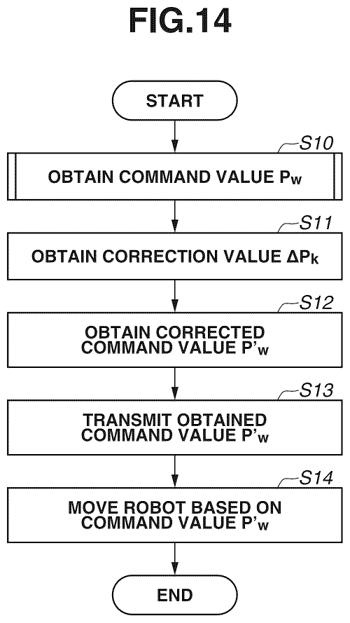

Next, a control process for the robot 5 using the correction map according to the present exemplary embodiment will be described. FIG. 14 is a control flowchart for the robot 5 using the correction map according to the present exemplary embodiment. The method in the flowchart illustrated FIG. 14 is executed by the robot control apparatus 100. As illustrated in FIG. 14, initially in step S10, the command value P_{w} before correction is obtained from a work program to be executed by the robot 5 or from a user instruction. The command value P_{w} may be preliminarily set through user's teaching, or may be dynamically obtained using image processing or the like. Next, in step S11, the correction value ΔPₖ corresponding to the command value P_{w} is obtained from the correction map. Next, in step S12, the command value P′_{w} corrected through the method illustrated in FIG. 13 is obtained from the command value P_{w} and the correction value ΔPₖ. Next, the command value P′_{w} obtained in step S13 is transmitted as a command value to each driving device of the robot 5. Then, in step S14, the robot 5 is moved based on the command value P′_{w}.

According to the present exemplary embodiment described above, a correction map for a command value used to control the robot 5 is obtained from the positional information about the end effector 2 and the positional information about the marker 1 obtained from the image capturing apparatus 3. Specifically, positional information about the common position measurement target, namely, the marker 1, is measured by the robot 5 and the image capturing apparatus 3, which have different measurement methods and different measurement mechanisms. Thus, in obtaining the correction map, factors attributable to the robot mechanism can be reflected using the positional information about the marker 1 obtained from the positional information about the end effector 2. Factors attributable to the calibration between the image capturing apparatus 3 and the robot 5 can be also reflected using the positional information about the marker 1 measured by the image capturing apparatus 3. Thus, the control of the robot 5 using the obtained correction map enables obtainment of a command value for correcting the factors attributable to the robot mechanism and the factors attributable to the calibration between the image capturing apparatus 3 and the robot 5, thus improving the operation accuracy of the robot 5.

Next, a second exemplary embodiment will be described. In the following description, components that are identical or correspond to those of the first exemplary embodiment are denoted by the same reference numerals, and descriptions thereof are omitted or simplified. Only differences from the first exemplary embodiment will be mainly described. The second exemplary embodiment illustrates an example where the image capturing apparatus 3 is fixed to the end effector 2 and a hand-mounted camera that follows the motion of the robot 5 is used as the image capturing apparatus 3.

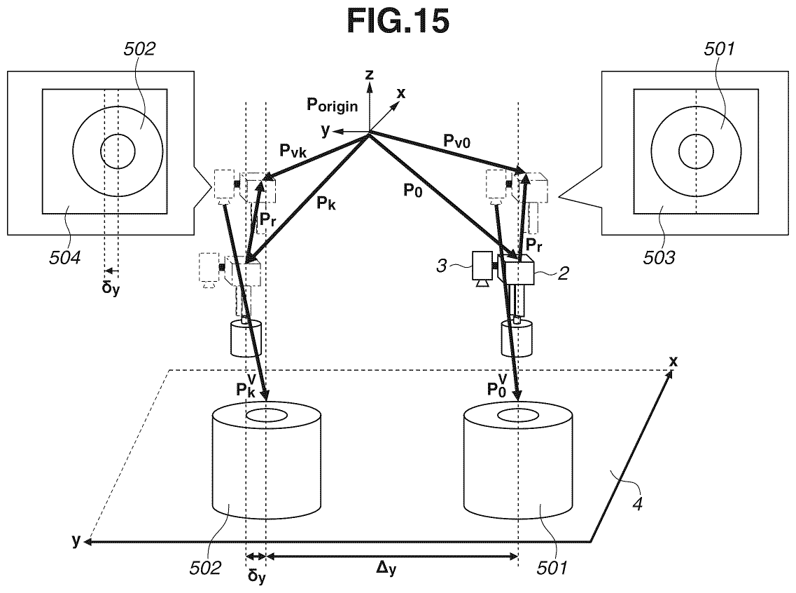

FIG. 15 illustrates an outline of a workpiece assembly using the hand-mounted image capturing apparatus 3.

There is a case where the same work is to be repeatedly performed on a plurality of workpieces within the working area 4. In such a case, at a representative point, the image capturing position Pᵥ₀ and a working position P₀ with the robot origin P_{origin} as the reference position are taught and a relative relationship Pᵣ between the image capturing position Pᵥ₀ and the working position P₀ is obtained (calculated) in advance. Next, using designed dimensions Δy, the robot control apparatus 100 obtains (generates) a working position Pₖ and an image capturing position Pᵥₖ, which are horizontally shifted by Δy within the working plane from the working position P₀ and the image capturing position Pᵥ, with the robot origin P_{origin} as the reference.

In this case, the working position Pₖ and the image capturing position Pᵥₖ can deviate from target positions by δy in a workpiece 502 due to the difference between the designed dimensions and the actual dimensions. In this case, the difference between the measured position P^{V}₀ of a to-be-assembled workpiece 501 imaged at the imaging capturing position Pᵥ₀ and the measured position P^{V}ₖ of the to-be-assembled workpiece 501 imaged at the imaging capturing position Pᵥₖ corresponds to δy. Thus, a plurality of work positions Pₖ can be obtained (generated) without any teaching work by adding δy to the working position Pₖ. δy can be generally obtained through image processing. A displacement amount between the workpiece 501 imaged in a reference image 503 which is captured at the image capturing position Pᵥ₀ and the workpiece 502 imaged in a shift image 504 which is captured at the image capturing position Pᵥₖ corresponds to δy.

In this case, the working position Pₖ to be actually taken by the actual robot 5 and the image capturing position Pᵥₖ may be different from the positions indicated by a command value due to factors attributable to the robot mechanism and factors attributable to the calibration between the image capturing apparatus 3 and the robot 5. For this reason, the working position Pₖ is to be corrected within the working area 4 using the correction map.

In the present exemplary embodiment, a correction map can also be obtained by executing processing similar to that illustrated in FIG. 4. However, in the case of calculating the correction value in step S7, the correction value ΔPₖ is obtained (calculated) using the following expression based on the measured position P^{V}ₖ of the workpiece measured by the image capturing apparatus 3 with the measured position P^{V}₀ of the workpiece measured at the image capturing position Pᵥ₀ serving as a reference. Then, the command value is corrected through the same method as that used when an overhead camera is used, as in the first exemplary embodiment using the obtained correction value, and the control flowchart illustrated in FIG. 14 is executed to thereby correct the operation of the robot 5.

$${( Δ {P}_{k} )}_{x} = {( {P}_{0}^{V} )}_{x} - {( {P}_{k}^{V} )}_{x} {( Δ {P}_{k} )}_{y} = {( {P}_{0}^{V} )}_{y} - {( {P}_{k}^{V} )}_{y} \qquad Equation ( 3 )$$

According to the present exemplary embodiment described above, a correction map is obtained so that the correction processing in which factors attributable to the robot mechanism and factors attributable to the calibration between the image capturing apparatus 3 and the robot 5 are reflected can be executed. Thus, the control of the robot 5 using the obtained correction map makes it possible to obtain the command value for correcting the factors attributable to the robot mechanism and the factors attributable to the calibration between the image capturing apparatus 3 and the robot 5, improving the operation accuracy of the robot 5. The above-described various exemplary embodiments and modified examples may be performed in combination.

Next, a third exemplary embodiment will be described. In the following descriptions, components that are identical or correspond to those of the first and second exemplary embodiments are denoted by the same reference numerals, and descriptions thereof are omitted or simplified. Only differences from the first and second exemplary embodiments will be mainly described. The third exemplary embodiment exemplifies a case where a stereo image capturing apparatus is used as the image capturing apparatus 3.

In this case, the image capturing apparatus 3 may be a binocular stereo camera or a sensor having a three-dimensional measurement function such as a Light Detection And Ranging (LiDAR) based function. The stereo camera may be fixed to a position at which the working area 4 can be visually recognized and overlooked, or may be fixed to the robot 5 or the end effector 2 as a hand-mounted camera.

In the case of using a stereo camera as the image capturing apparatus 3 as in the present exemplary embodiment, the correction map can be obtained by executing the processing illustrated in FIG. 4. To measure the position of the marker 1 in step S5 illustrated in FIG. 4, an alignment method using a known technique, such as an Interactive Closest Point (ICP) algorithm using a three-dimensional point group, may be used. A matching method using a combination of point group information and edge information within an image may also be used.

A correction map can be obtained in a manner similar to that in the first exemplary embodiment or the second exemplary embodiment using the obtained positional information about the marker 1.

According to the present exemplary embodiment described above, a correction map is obtained so that correction processing reflecting factors attributable to the robot mechanism and factors attributable to the calibration between the image capturing apparatus 3 and the robot 5 is executed. This allows for the acquisition of command values that can correct the effects of factors attributable to the robot mechanism and the factors attributable to the calibration between the image capturing apparatus 3 and the robot 5 through control of the robot 5 using the obtained correction map, thereby improving the operation accuracy of the robot 5. The above-described various exemplary embodiments and modified examples may be carried out in combination.

Next, a fourth exemplary embodiment will be described. In the following description, components that are identical or correspond to those of the first to third exemplary embodiments are denoted by the same reference numerals, and descriptions thereof are omitted or simplified. Only differences from the first to third exemplary embodiments will be mainly described. In the fourth exemplary embodiment, a position at which the marker 1 is placed is set by the user using a graphical user interface (GUI).

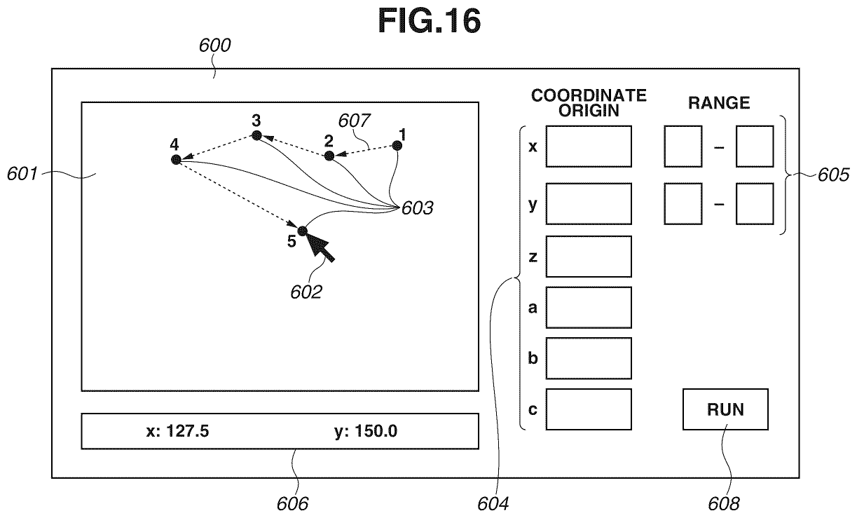

FIG. 16 illustrates a state where a workpiece placement position is determined using a GUI 600. Assume that the GUI 600 is displayed on the display 107 that is communicably connected to the robot control apparatus 100. The GUI 600 includes a placement point designation window 601, a working area coordinate origin input window 604, a working area range designation window 605, a placement position indicator 606, and a run button 608.

Initially, the user inputs an origin orientation on a workpiece placement surface in the working area 4 to the working area coordinate origin input window 604. “x”, “y”, and “z” represent positional information in a three-dimensional space, and “a”, “b”, and “c” represent orientation information represented as angular information about each axis. In this case, angular information is input as an Euler angle. Next, a minimum value and a maximum value of xy coordinates where the marker 1 can be placed are input to the working area range designation window 605. A left-side field in the working area range designation window 605 in FIG. 16 indicates a minimum value and a right-side field in the working area range designation window 605 in FIG. 16 indicates a maximum value. Alternatively, the right-side field may indicate a minimum value and the left-side filed may indicate a maximum value.

Next, the user can add a placement position 603 by clicking an area on the placement point designation window 601 with a mouse cursor 602. In this case, the coordinate values within the xy-plane in the working area 4 indicated by the mouse cursor 602 are constantly displayed on the placement position indicator 606. The display of the placement position indicator 606 is updated depending on the position of the mouse cursor 602 in the working area 4 on the placement point designation window 601.

The placement point designation window 601 virtually displays the range input to the working area range designation window 605. This configuration prevents an area outside the range of the working area 4 from being designated, irrespective of the designated area on the placement point designation window 601. This leads to a reduction in erroneous setting of the placement position for the marker 1 to a position outside the range of the working area 4. As a matter of course, the working area 4 may be highlighted using a dashed line, a solid line, or the like on the placement point designation window 601, and the entire working area 4 may be displayed on the placement point designation window 601.

The working area 4 may be zoomed in or zoomed out. If the working area 4 is located on the table 400, the table 400 may be virtually displayed on the placement point designation window 601 and the working area 4 may be displayed on the table 400 that is virtually displayed. Such display may be used to transmit various information to the user.

The placement order of placement positions 603 is in the order in which placement positions 603 have been set, and on the GUI 600, the execution order is indicated by an arrow 607. The execution order of the placement positions 603 may be displayed by numbers in the vicinity of the respective placement positions 603. The execution order of the placement positions 603 can be changed by designating the arrow 607 with the mouse cursor 602 to change the connection relationship, or by designating and changing numbers with the mouse cursor 602. The set placement positions 603 can be moved on the placement point designation window 601 by drag and drop using the mouse cursor 602.

The set placement position 603 can be deleted by right-clicking the mouse 105 to display a pull-down menu and selecting “delete”. If a placement position 603 is deleted, placement points preceding and succeeding the deleted placement position 603 are connected by the arrow 607, or at least one of the numbers preceding and succeeding the deleted placement position 603 is changed and the placement execution order is also changed to the order excluding the deleted placement position 603. For example, if the placement position 603 with an execution order “2” is deleted, the placement position 603 indicated by “1” and the placement position 603 indicated by “3” are connected by the arrow 607. Alternatively, the number “3” of the placement position 603 is changed to “2”.

The user feely sets placement positions 603 and then presses the run button 608, thus transferring coordinate information about all the placement positions 603 to the robot control apparatus 100. In this case, the coordinate information to be transferred is six-axis coordinate information about each placement point with the coordinate origin as a reference. In the present exemplary embodiment, the respective placement positions 603 are represented by coordinate values on the xy-plane, and the placement orientation is not changed based on the placement position. Accordingly, values “z”, “a”, “b”, and “c” represent information about the coordinate origin and information about “x” and “y” varies depending on the corresponding placement position 603. If the working area 4 is located in a three-dimensional space, information about “z” also varies depending on the placement position 603 in an exemplary embodiment. The robot control apparatus 100 that has obtained information about the placement position can place the marker 1 based on the placement position set by the user and can obtain the correction map in the control flowchart illustrated in FIG. 4.

According to the present exemplary embodiment described above, the correction map for a command value to be used for the control of the robot 5 is obtained from the positional information about the end effector 2 and the positional information about the marker 1 obtained from the image capturing apparatus 3. In other words, positional information about the common position measurement target, namely, the marker 1, is measured by the robot 5 and the image capturing apparatus 3 having different measurement methods and different measurement mechanisms. Thus, in obtaining the correction map, factors attributable to the robot mechanism can be taken into consideration using the positional information about the end effector 2 and factors attributable to the calibration between the image capturing apparatus 3 and the robot 5 can be taken into consideration. Consequently, the control of the robot 5 using the obtained correction map makes it possible to obtain a command value for correcting the effects of factors attributable to the robot mechanism and the factors attributable to the calibration between the image capturing apparatus 3 and the robot 5. This enables the improvement of the robot's operational accuracy. The GUI facilitates setting of placement positions of the marker 1 and obtaining of the correction map.

### OTHER EXEMPLARY EMBODIMENTS

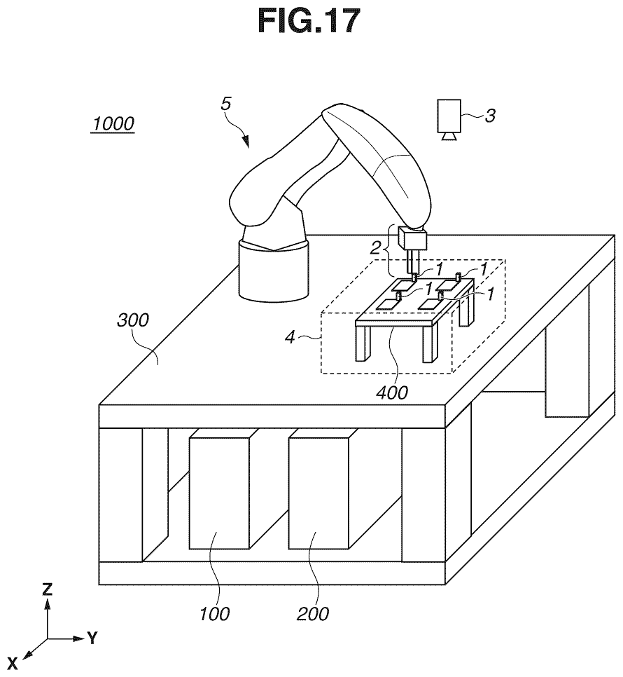

Next, other exemplary embodiments of the present disclosure will be described in detail. FIG. 17 illustrates an exemplary embodiment to which the present disclosure can be applied. In the exemplary embodiment illustrated in FIG. 17, at least two markers 1 are arranged on the table 400 in advance. Finger portions of the end effector 2 are sequentially brought into contact with or caused to grip the markers 1 arranged on the table 400, thus obtaining a position of a predetermined portion of the end effector 2 when the finger portions are brought into contact with or caused to grip the markers 1. The position of the predetermined portion may be set at a leading end of each finger portion of the end effector 2, or may be a flange or the like. Then, the end effector 2 is retracted by the robot 5 and the position of each marker 1, which is brought into contact or gripped, is obtained by the image capturing apparatus 3. The position of each marker 1 arranged on the table 400 may be obtained by the image capturing apparatus 3 before the robot 5 is brought into contact with or caused to grip the marker 1.

According to the exemplary embodiment illustrated in FIG. 17 described above, the correction map for a command value to be used to control the robot 5 is obtained from the positional information about the end effector 2 and the positional information about the markers 1 measured by the image capturing apparatus 3. In other words, positional information about the common position measurement target, namely, the marker 1, is measured by the robot 5 and the image capturing apparatus 3 having different measurement methods and different measurement mechanisms. Thus, in obtaining the correction map, factors attributable to the robot mechanism can be taken into consideration based on the positional information about the markers 1 obtained from the positional information about the end effector 2. Additionally, factors attributable to the calibration between the image capturing apparatus 3 and the robot 5 can be taken into consideration based on the positional information about the markers 1 measured by the image capturing apparatus 3. Thus, the control of the robot 5 using the obtained correction map makes it possible to obtain a command value for correcting the effects of the factors attributable to the robot mechanism and the factors attributable to the calibration between the image capturing apparatus 3 and the robot 5, thereby improving the operation accuracy of the robot 5.

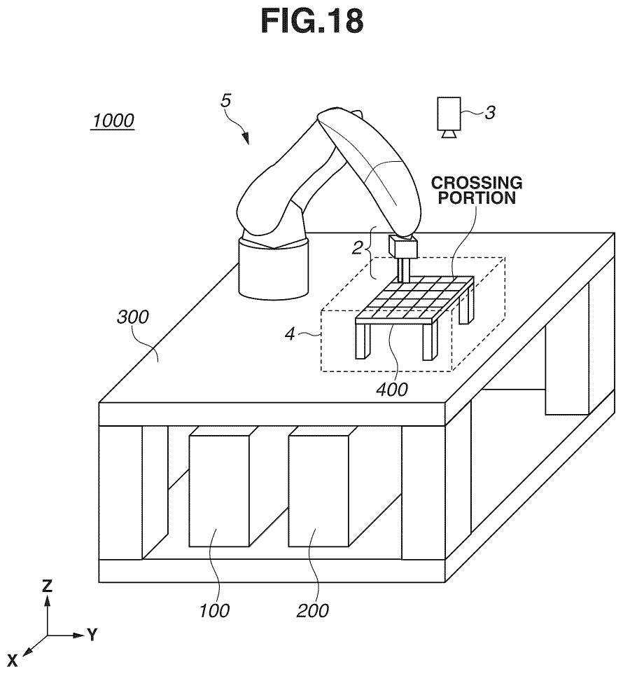

Next, other exemplary embodiments of the present disclosure will be described in detail. FIG. 18 illustrates an exemplary embodiment to which the present disclosure can be applied. In the exemplary embodiment illustrated in FIG. 18, the table 400 is provided with a groove having a lattice shape. Each crossing portion of the lattice shape is caused to function as a marker. It is sufficient to provide at least two crossing portions. The finger portions of the end effector 2 are sequentially brought into contact with the crossing portion of the groove on the table 400, thus obtaining a position of a predetermined portion of the end effector 2 when the finger portions are brought into contact with the crossing portion. The position of the predetermined portion may be set at a leading end of each finger portion of the end effector 2, or may be a flange or the like. Further, the end effector 2 is retracted by the robot 5 and the position of the crossing portion in contact with the end effector 2 is obtained by the image capturing apparatus 3. The position of each crossing portion provided on the table 400 may be obtained by the image capturing apparatus 3 before the robot 5 is brought into contact with the crossing portion. While the exemplary embodiment illustrated in FIG. 18 illustrates an example where a groove having a lattice shape is used, a groove of any shape may be used as long as the groove can function as a marker. Instead of using the groove as illustrated in FIG. 18, any portion, such as a flaw on the table 400, may be used as long as the portion can function as a marker.

According to the exemplary embodiment illustrated in FIG. 18 described above, a correction map for the command value to be used to control the robot 5 is obtained from the positional information about the end effector 2 and the positional information about each crossing portion measured by the image capturing apparatus 3. In other words, positional information about the common position measurement target, which is a crossing portion, is measured by the robot 5 and the image capturing apparatus 3 having different measurement methods and different measurement mechanisms. Thus, in obtaining the correction map, factors attributable to the robot mechanism can be taken into consideration using the positional information about each crossing portion obtained from the positional information about the end effector 2. Additionally, factors attributable to the calibration between the image capturing apparatus 3 and the robot 5 can be taken into consideration using the positional information about each crossing portion obtained from the image capturing apparatus 3. Thus, the control of the robot 5 using the obtained correction map makes it possible to obtain the command value for correcting the effects of the factors attributable to the robot mechanism and the factors attributable to the calibration between the image capturing apparatus 3 and the robot 5, thus improving the operation accuracy of the robot 5.

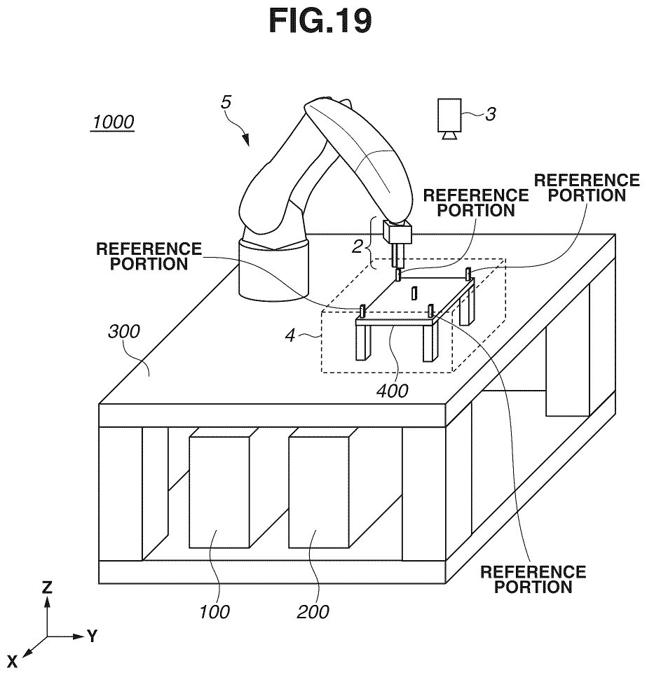

Next, other exemplary embodiments of the present disclosure will be described in detail. FIG. 19 illustrates an exemplary embodiment to which the present disclosure can be applied. In the exemplary embodiment illustrated in FIG. 19, at least two reference portions each serving as a portion functioning as a marker are provided on the table 400. The finger portions of the end effector 2 are sequentially brought into contact with or caused to grip each reference portion provided on the table 400, thus obtaining a position of a predetermined portion of the end effector 2 when the finger portions are brought into contact with or caused to grip the reference portion. The position of the predetermined portion may be set at a leading end of each finger portion of the end effector 2, or may be a flange or the like. Further, the end effector 2 is retracted by the robot 5 and the position of each reference portion, which is brought into contact or gripped, is obtained by the image capturing apparatus 3. The position of each reference portion arranged on the table 400 may be obtained by the image capturing apparatus 3 before the robot 5 is brought into contact with or caused to grip the reference portion.

According to the exemplary embodiment illustrated in FIG. 19 described above, a correction map for the command value to be used to control the robot 5 is obtained from the positional information about the end effector 2 and the positional information about each reference portion measured by the image capturing apparatus 3. In other words, positional information about the common position measurement target, which is the reference portion, is measured by the robot 5 and the image capturing apparatus 3 having different measurement methods and different measurement mechanisms. Thus, in obtaining the correction map, factors attributable to the robot mechanism can be taken into consideration using the positional information about each reference portion obtained from the positional information about the end effector 2. Factors attributable to the calibration between the image capturing apparatus 3 and the robot 5 can be taken into consideration using the positional information about the marker 1 obtained from the image capturing apparatus 3. Thus, the control of the robot 5 using the obtained correction map makes it possible to obtain a command value for correcting the effects of the factors attributable to the robot mechanism and the factors attributable to the calibration between the image capturing apparatus 3 and the robot 5, thus improving the operation accuracy of the robot 5.

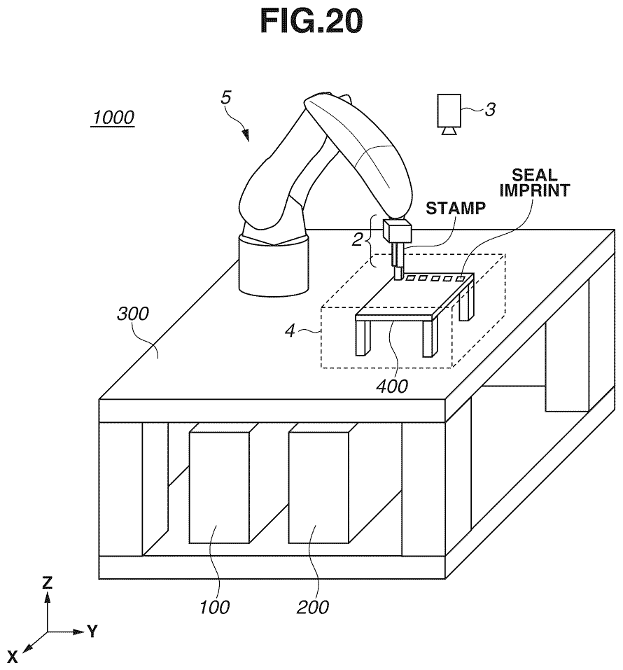

Next, other exemplary embodiments of the present disclosure will be described in detail. FIG. 20 illustrates an exemplary embodiment to which the present disclosure can be applied. In the exemplary embodiment illustrated in FIG. 20, the end effector 2 is caused to grip a stamp configured to form a seal imprint with ink, and the stamp forms at least two seal imprints each functioning as a marker on the table 400. At least two seal imprints are formed on the table 400 by printing imprints on at least two positions using the stamp gripped by the end effector 2. Further, a position of a predetermined portion of the end effector 2 when the stamp is pressed to form an imprint on the table 400 is obtained. The position of the predetermined portion may be set at a position of a leading end of each finger portion of the end effector 2, or may be flange or the like. A leading end of the stamp may also be usable as long as gripping accuracy of the stamp is high. After the imprint is formed by the stamp, the end effector 2 is retracted by the robot 5 and the position of each seal imprint is obtained by the image capturing apparatus 3. After a plurality of seal imprints is formed on the table 400, the order of forming the seal imprints is stored. Further, the image capturing apparatus 3 may obtain the position of each seal imprint arranged on the table 400 and may associate the position of each seal imprint with the stored order of forming the seal imprints.

While the exemplary embodiment illustrated in FIG. 20 illustrates an example where each seal imprint is formed by a stamp, each seal imprint may be formed by a dispenser configured to eject a predetermined amount of ink. It is desirable to use aqueous ink in consideration of a work to be subsequently executed on the table 400. This enables the user or the robot 5 to more easily clean the seal imprints that have been formed to obtain the positional information. Depending on the work to be subsequently executed, oil ink may also be used. Depending on the work to be subsequently executed, a mark may be formed using a stamp on the table 400.

According to the exemplary embodiment illustrated in FIG. 20 described above, a correction map for the command value to be used to control the robot 5 is obtained from the positional information about the end effector 2 and the positional information about each seal imprint obtained from the image capturing apparatus 3. In other words, positional information about the common position measurement target, which is a seal imprint, is measured by the robot 5 and the image capturing apparatus 3 having different measurement methods and different measurement mechanisms. Thus, in obtaining the correction map, factors attributable to the robot mechanism can be taken into consideration using the positional information about each seal imprint obtained from the positional information about the end effector 2. Factors attributable to the calibration between the image capturing apparatus 3 and the robot 5 can be taken into consideration using the positional information about each seal imprint obtained from the image capturing apparatus 3. Thus, the control of the robot 5 using the obtained correction map makes it possible to obtain a command value for correcting the effects of the factors attributable to the robot mechanism and the factors attributable to the calibration between the image capturing apparatus 3 and the robot 5, thus improving the operation accuracy of the robot 5.

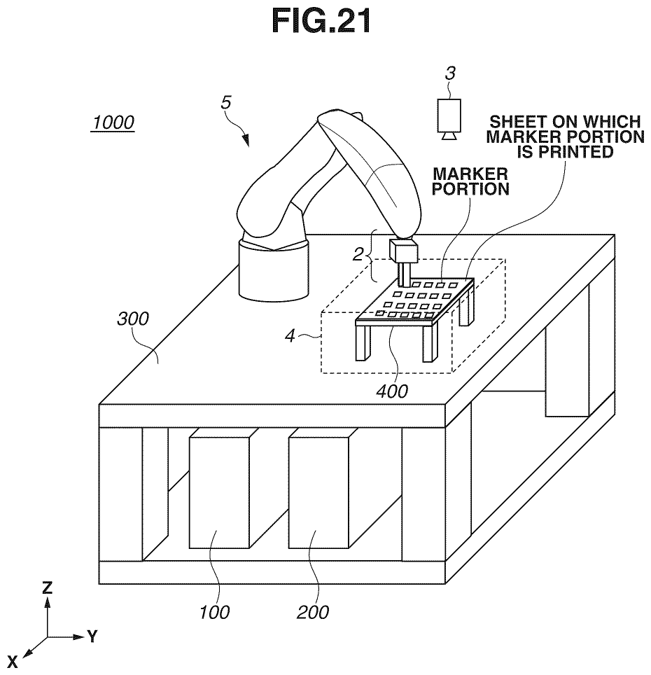

Next, other exemplary embodiments of the present disclosure will be described in detail. FIG. 21 illustrates an exemplary embodiment to which the present disclosure can be applied. In the exemplary embodiment illustrated in FIG. 21, a sheet on which at least two portions each functioning as a marker are printed is placed on the table 400. The sheet is placed on the table 400 in such a manner that the sheet is not displaced on the table 400 even when the end effector 2 is brought into contact with the sheet. The finger portions of the end effector 2 are sequentially brought into contact with each marker portion printed on the sheet on the table 400, thus obtaining a position of a predetermined portion of the end effector 2 when the finger portions are brought into contact with the marker portion. The position of the predetermined portion may be set at a position of a leading end of each finger portion of the end effector 2, or may be a flange or the like. Further, the end effector 2 is retracted by the robot 5 and the position of the marker portion, which is brought into contact, is obtained by the image capturing apparatus 3. The position of each marker portion on the sheet on the table 400 may be obtained by the image capturing apparatus 3 before the robot 5 is brought into contact with the marker portion.

According to the exemplary embodiment illustrated in FIG. 21 described above, a correction map for the command value used to control the robot 5 is obtained from the positional information about the end effector 2 and the positional information about each marker portion obtained from the image capturing apparatus 3. In other words, positional information about the common position measurement target, that is, the marker portion, is measured by the robot 5 and the image capturing apparatus 3 having different measurement methods and different measurement mechanisms. Thus, in obtaining the correction map, factors attributable to the robot mechanism can be taken into consideration using the positional information about each marker portion obtained from the positional information about the end effector 2. Factors attributable to the calibration between the image capturing apparatus 3 and the robot 5 can be taken into consideration using the positional information about each marker portion obtained from the image capturing apparatus 3. Thus, the control of the robot 5 using the obtained correction map makes it possible to obtain a command value for correcting the effects of the factors attributable to the robot mechanism and the factors attributable to the calibration between the image capturing apparatus 3 and the robot 5, thus improving the operation accuracy of the robot 5.

Specifically, the processing procedure according to the exemplary embodiments described above is executed by at least one CPU or a user input. Accordingly, the above-described functions may be executed by reading a storage medium storing a software program for executing the functions. In this case, the program read from the storage medium implements the functions according to the exemplary embodiments described above, and the program itself and the storage medium storing the program constitute the present disclosure.

The exemplary embodiments described above illustrate an example where computer-readable storage media are ROMs, RAMs, or flash ROMs, and the program is stored in a ROM, a RAM, or a flash ROM. However, the present disclosure is not limited to this configuration. The program for carrying out the present disclosure may be stored in any computer-readable storage medium. An SSD may be used as a storage unit.

In the exemplary embodiments described above, a correction map on the xy-plane is obtained. However, the configuration of the correction map is not limited to this example. For example, in the case of obtaining the correction map in a three-dimensional space, the placement surface for the marker 1 on the table 400 or the base 300 may be configured to be variable in the z-axis direction. Further, the placement surface is located at a predetermined position in the z-axis direction and the markers 1 are located on at least two positions, thus obtaining information about each position. After that, the placement surface for the marker 1 is moved in the z-axis direction by a predetermined increment, the markers 1 are placed on at least two positions again, and information about each position is obtained. This process is repeated within the range of the z-axis direction in the working area 4, so that the correction map in the three-dimensional space is obtained.

In the various exemplary embodiments described above, for example, a vertically articulated robot, a horizontally articulated robot, a parallel-link robot, or a Cartesian coordinate robot may be used. The various exemplary embodiments described above are applicable to machines capable of automatically performing expansion and contraction, bending and stretching, vertical movement, horizontal movement, or turning, or combinations of these operations, based on information in a storage device provided in a control apparatus.

The present disclosure is not limited to the above-described exemplary embodiments and can be modified in various ways within the technical scope of the present disclosure. The advantages effects described in the exemplary embodiments of the present disclosure are merely examples of the most advantageous effects obtained from the present disclosure. The advantageous effects of the present disclosure are not limited to those described in the exemplary embodiments of the present disclosure. The above-described various exemplary embodiments and modified examples may be carried out in combination.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-070112, filed Apr. 23, 2024, which is hereby incorporated by reference herein in its entirety.

What is claimed is:

1. A method for a robot controlled by an image capturing apparatus, the method comprising:
causing a control apparatus to obtain information about a position of a portion functioning as a marker to be obtained by the robot and information about a position of the portion functioning as the marker to be obtained by the image capturing apparatus; and
controlling the robot based on the information about the position of the portion functioning as a marker to be obtained by the robot and the information about the position of the portion functioning as the marker to be obtained by the image capturing apparatus.

2. The method according to claim 1, wherein information about a position of a predetermined portion of the robot in a case where the portion functioning as the marker is placed by the robot is obtained as the information about the position of the portion functioning as the marker.

3. The method according to claim 2, wherein the method causes the control apparatus to obtain information indicating a correction value for correcting a command value for controlling the robot based on the information about the position of the predetermined portion of the robot and the information about the position of the placed portion functioning as the marker obtained by the image capturing apparatus.

4. The method according to claim 2, wherein the method causes the control apparatus to obtain the information about the position of the predetermined portion of the robot in a case where the robot releases the portion functioning as the marker.

5. The method according to claim 2, wherein the method causes, in a case where the portion functioning as the marker is to be placed by the robot, the control apparatus to obtain the information about the position of the predetermined portion of the robot determined to have stabilized before the portion functioning as the marker is released.

6. The method according to claim 2, wherein the control method causes the control apparatus to obtain the information about the position of the predetermined portion of the robot in a state where the portion functioning as the marker is brought into contact with a location where the portion functioning as the marker is to be placed.

7. The method according to claim 5, wherein the method causes the control apparatus to obtain the information about the position of the predetermined portion of the robot in a case where information about a force obtained by bringing the portion functioning as the marker into contact with the location where the portion functioning as the marker is to be placed is in a predetermined state.

8. The method according to claim 1, wherein a position at which the portion functioning as the marker is to be placed is settable by a user and a working area for the robot is settable by the user.

9. The method according to claim 7, wherein a notification of an execution order at the position at which the portion functioning as the marker is to be placed is transmitted to the user and the execution order is updated in a case where the user deletes the position at which the portion functioning as the marker is to be placed.

10. The method according to claim 9, wherein the method causes the control apparatus to obtain the information indicating the correction value for correcting the command value based on the information about the position of the predetermined portion of the robot, the information about the position of the placed portion functioning as the marker obtained by the image capturing apparatus, and a reference position for control execution for the robot.

11. The method according to claim 9, wherein the information indicating the correction value is in at least one of a map form, a functional form, or a tabular form.

12. The method according to claim 9, wherein the method causes the control apparatus to obtain a position other than the position at which the portion functioning as the marker has been placed in the information indicating the correction value as a weighted average of differences obtained at positions in a vicinity each of which the portion functioning as the marker has been placed.

13. The method according to claim 9, wherein the method causes the control apparatus to visualize the information indicating the correction value using an arrow representing an amount and an orientation as a size and a direction, respectively, with the position at which the portion functioning as the marker is placed as a starting point.

14. The method according to claim 1, wherein the method causes the control apparatus to obtain the information about the position of the portion functioning as the marker in a state where the portion is preliminarily placed by the robot and the information about the position of the portion functioning as the marker obtained by the image capturing apparatus.

15. The method according to claim 1, wherein the portion functioning as the marker is at least one of a groove, a reference portion disposed in a working area for the robot, a seal imprint to be formed using a stamp controlled by the robot, or a mark to be formed using a stamp controlled by the robot.

16. The method according to claim 1, wherein the portion functioning as the marker is printed on a sheet.

17. An article manufacturing method comprising:
manufacturing an article by controlling a robot based on a method according to claim 1.

18. A control apparatus for controlling a robot using an imaging capturing apparatus, the control apparatus comprising:
a memory storing a program; and
a processor, that when executing the program, causes the control apparatus to:
obtain information about a position of a portion functioning as a marker to be obtained by the robot and information about a position of the portion functioning as the marker to be obtained by the image capturing apparatus, and
control the robot based on the information about the position of the portion functioning as a marker to be obtained by the robot and the information about the position of the portion functioning as the marker to be obtained by the image capturing apparatus.

19. A method for obtaining information about a robot to be controlled by an image capturing apparatus, the method comprising:
obtaining information about a position of a portion functioning as a marker to be obtained by the robot and information about a position of the portion functioning as the marker to be obtained by the image capturing apparatus.

20. A non-transitory computer-readable recording medium storing a program for executing the method according to claim 1.
